(19) United States
(12) Patent Application Publication
(10) Pub. No.: US 2003/0178399 A1
(43) Pub. Date: Sep. 25, 2003

(54) Laser brazing of aluminum alloys

(75) Inventors: Tibor Horbasz, Nepean (CA); Janos Takacs, Budapest (HU); Heinz-Joachim Belt, Burgwedel (DE)

Correspondence Address: CROWELL & MORING LLP, INTELLECTUAL PROPERTY GROUP, P.O. BOX 14300, WASHINGTON, DC, 20044-4300, US

(73) Assignee: Solvay Fluor und Derivate GmbH, Hannover (DE)

(21) Appl. No.: 10/291,742

(22) Filed: Nov. 12, 2002

Related U.S. Application Data
(63) Continuation of application No. PCT/EP01/04913, filed on May 2, 2001.

(30) Foreign Application Priority Data
May 10, 2000 (DE) 10022840.2

(51) Int. Cl. B23K 1/005

(52) U.S. Cl. 219/121.85

(57) ABSTRACT

A process for laser brazing of aluminum alloys, in which joints are coated with an agent which absorbs laser energy. Fluxes suitable for brazing aluminum, in particular potassium fluoroaluminate-containing fluxes, flux pastes or flux/metal powder mixtures, are used as the agents which absorb laser energy.

### CROSS REFERENCE TO RELATED APPLICATIONS

This application is a continuation of international patent application no. PCT/EP01/04913, filed May 2, 2001 designating the United States of America and published in German as WO 01/85378, the entire disclosure of which is incorporated herein by reference. Priority is claimed based on Federal Republic of Germany patent application no. DE 100 22 840.2, filed May 10, 2000.

### BACKGROUND OF THE INVENTION

The present invention relates to a process for laser brazing of aluminum alloys using a suitable flux.

In brazing, metallic materials are joined using a molten brazing material or hard solder. Fluxes are used in brazing to ensure a clean surface and hence secure joining of the materials.

Laser brazing represents an alternative thermal joining process for bonding together e.g. components made of aluminum alloys or components made of aluminum alloy and components made of other materials. The use of laser radiation is especially preferred where it is important that only a part of the components to be joined is subjected to heat.

In laser brazing, the necessary heat is focussed by converting collimated high-energy radiation as it impinges on the workpiece. The absorbed portion of the laser radiation heats the workpiece to brazing temperature and melts the solder, so that it can wet the surfaces to be joined.

From the point of view of an effective brazing process, the absorption of the laser radiation is of central significance, since only the energy component of the laser radiation is available for the joining process. The absorption rate may be improved e.g. by suitable coating agents. For example, a graphite coating may be used to increase the laser energy absorption rate of steel. However, graphite is not suitable for joining aluminum alloys due to its corrosive properties.

### SUMMARY OF THE INVENTION

It is an object of the present invention to provide an improved process for laser brazing of aluminum alloys.

A further object of the invention is to provide a process for laser brazing of aluminum alloys in which an auxiliary substance is utilized to absorb laser energy.

These and other objects are achieved in accordance with the present invention by providing a process for laser brazing of components made of an aluminum alloy, wherein locations on the components which are to be joined are coated with an agent which absorbs laser energy.

### DETAILED DESCRIPTION OF PREFERRED EMBODIMENTS

In accordance with the present invention, aluminum components are coated at the point which is to be joined with one or more auxiliary substances which absorb laser energy. Homogenous wetting or coating should be ensured in order to produce accurate soldered joints. As used herein, the term “aluminum components” is understood to refer to components made of aluminum alloys.

Fluxes suitable for brazing aluminum, in particular potassium fluoroaluminate-containing fluxes, flux pastes or flux/metal powder mixtures, preferably are used as auxiliary substances which absorb laser energy. The term “potassium fluoroaluminate” refers to known complex aluminum fluorides of potassium which are composed of potassium, aluminum, fluorine and optionally water. Preferred fluxes likewise include cesium fluoroaluminate fluxes or mixtures of these fluxes with Al/Si, Al/Zn or Si powder. Active fluxes such as K₂SiF₆, KZnF or CsSiF are likewise suitable.

Fluxes within the scope of the invention may, for example, comprise KAlF₄, K₂AlF₅, K₂AlF₃.H₂O or K₃AlF₆ as a potassium fluoroaluminate. In this case, the pentafluoroaluminate may also be present in the form of irreversibly dehydrated products.

The flux may be used as such, or it optionally may be used together with conventional auxiliaries.

For example, a binder, which improves the adhesion of the flux to the surface of the aluminum components which are to be joined, may be provided as an additional auxiliary.

Advantageously, the flux is used in the form of a flux preparation which contains the flux as a slurry or paste in water, an organic liquid or a mixture of water and organic liquid. As used herein, the term “organic liquid” is to be understood to mean alcohols in particular methanol, ethanol, propanol or isopropanol.

To prepare the preparation, e.g. K₂SiF₆ and potassium fluoroaluminate may be mixed individually or as a mixture with the liquid phase.

The content of water or of the organic liquid is adjusted such that the resulting slurry or paste has the desired consistency for handling and application to the components to be joined.

The joints to be soldered may be coated in a conventional manner, e.g. by spraying, sprinkling, scattering or brushing.

The aluminum alloy metal surface is advantageously coated with from 3 to 50 g/m² of the auxiliary which absorbs laser energy. If the auxiliary is a flux or flux mixture, the metal surface is advantageously loaded with from 10 to 20 g/m² of the auxiliary substance. If a flux/metal powder mixture is used as the auxiliary, the metal surface is advantageously loaded with from 30 to 40 g/m² of the auxiliary mixture.

It has been found that aluminum alloys of different compositions, particularly Mg-containing aluminum alloys, can be soldered by a laser beam using an auxiliary substance as described above, which absorbs laser energy.

The process is likewise suitable for joining solder-plated aluminum alloys.

Laser brazing of aluminum alloys with other metals, such as steel, copper, iron, titanium etc., also is made possible by coating the joints with the aforementioned auxiliaries.

The brazing operations may be carried out with either continuous or pulsed laser radiation. Examples of suitable lasers which may be used include Nd:YAG-solid-state lasers and CO₂ lasers.

The laser beam power directly determines the power density and the heat input. The brazing rate is directly dependent on the heat input. The process gas used and the respective quantity of process gas in the region of the zone of interaction of the brazing process influences the oxidation and/or depending on the type of gas also the reduction of the brazing surface.

In one preferred embodiment, a CO₂ laser with a power of 1.5 kW was used.

Due to the characteristic short brazing times, brief beam/material interaction of laser brazing and the small melting volumes which this involves, the spatial extent of the resulting joint is very narrow.

It has been found that aluminum plates having a thickness of up to 3 mm can be soldered without difficulty in accordance with the invention.

The laser brazing process according to the invention can be used e.g. in vessel fabrication and in vehicle manufacturing, in particular automobile manufacturing. It is also possible, for example, to solder thin foils.

The following examples are intended to illustrate the invention in further detail without limiting its scope.

### EXAMPLES

### Example 1

Aluminum plates 3 mm thick (100×20 mm) were coated at the joint with potassium fluoroaluminate (Nocolok) based on KAlF₄ and K₂AlF₅. The protective gas used was argon and the

laser used was a CO₂ laser (type OPL 1800).

| | |
|---|---|
| Laser gap width: | 2 mm |
| Brazing time: | 0.2 sec to 1 sec |
| Rate of advance: | 50 to 70 mm/minute |

### Example 2

The test was performed analogously to Example 1, with the joints being coated with K₂SiF₆.

Metallographic investigations of the joints showed that the crystalline structure of the joint is much finer than with conventional torch brazing.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations falling within the scope of the appended claims and equivalents thereof.

What is claimed is:

1. In a process for laser brazing components made of an aluminum alloy, the improvement comprising coating locations on the components which are to be joined with an agent which absorbs laser energy.

2. A laser brazing process according to claim 1, wherein the agent which absorbs laser energy comprises a flux, flux paste or flux/metal powder mixture suitable for brazing aluminum.

3. A laser brazing process according to claim 1, wherein said agent comprises a brazing flux selected from group consisting of cesium fluoroaluminate fluxes, potassium fluoroaluminate fluxes, and mixtures thereof with Al/Si, Al/Zn or Si powder.

4. A laser brazing process according to claim 1, wherein said agent comprises a brazing flux selected from the group consisting of K₂SiF₆, KZnF, CsSiF and mixtures thereof.

5. A laser brazing process according to claim 1, wherein the locations to be joined are coated with a coating of from 3 to 50 g/m² of the agent with absorbs laser energy.

6. A laser brazing process according to claims 1, wherein at least one component is made of a magnesium-containing aluminum alloy.

7. A laser brazing process according to claims 1, wherein at least one component is a solder-plated aluminum alloy component.

8. A laser brazing process according to claim 1, wherein a component made of an aluminum alloy is joined to a component made of another metal.

9. A laser brazing process according to claim 8, wherein said other metal is selected from the group consisting of steel, copper, iron and titanium.
